(19) United States
(12) Patent Application Publication
(10) Pub. No.: US 2026/0195335 A1
(43) Pub. Date: Jul. 9, 2026

(54) WORKFLOW FOR COLLATED INFORMATION RECORD

(71) Applicant: Honeywell International Inc., Charlotte, NC (US)

(72) Inventors: Ankit Singh, Apex, NC (US); Shaun Vallejo, Red Bank, NJ (US)

(21) Appl. No.: 19/008,701

(22) Filed: Jan. 3, 2025

(51) Int. Cl. G06F 16/25

(52) U.S. Cl. CPC G06F 16/254

(57) ABSTRACT

Techniques for recommending a workflow for generation of a collated information record are disclosed. Data descriptors are retrieved by parsing a record generation query. An interlinked operations set is determined, comprising operations to be performed for generating the collated information record. A facilitator tool set is identified to perform the operations and generate operation-facilitator tool combinations. A designated competent entity is then determined for each combination, being capable of executing an operation using a facilitator tool. A workflow signal is generated to render a recommended workflow for each designated competent entity, comprising the operation, the facilitator tool, and information to be collated. The recommended workflow is executable for generating the collated information record. Such an approach enables efficient and structured information collation by leveraging appropriate tools and competent entities to execute a series of interlinked operations based on specific requirements of the record generation query.

### BACKGROUND

In many scenarios, different types of data or records may be generated to provide information about various aspects or offerings. For example, such information records may be related to various offerings being offered by one or more organizations in the form of products, services, platforms, or other modes. In some cases, the data required to generate such information records or documents may be stored at different data sources and multiple tools may have to be used for the extraction, transformation, and loading of the data to develop such information records. These tools may facilitate the process of gathering, processing, and organizing data or information from various data sources into coherent and useful records.

### BRIEF DESCRIPTION OF DRAWINGS

The detailed description is described with reference to the accompanying figures. It should be noted that the description and figures are merely examples of the present subject matter and are not meant to represent the subject matter itself.

FIGS. 1A and 1B illustrate a block diagram of a computing environment 100, according to an example implementation of the present subject matter.

FIG. 2 illustrates a block diagram of a system, according to an example implementation of the present subject matter.

FIG. 3 illustrates a block diagram of a computing environment comprising the system, according to another example implementation of the present subject matter.

FIGS. 4A to 4C illustrate block diagrams of a few exemplary operation-tool combinations, according to one example implementation of the present subject matter.

FIGS. 5A to 5C illustrate block diagrams of a few exemplary combinations of one or more designated competent entities with the operation-tool combinations, according to one example implementation of the present subject matter.

FIGS. 6A to 6D illustrate block diagrams of a few exemplary workflows, according to one example implementation of the present subject matter.

FIGS. 7A and 7B illustrate a method for recommending a workflow to assist in generation of collated information record, according to an example implementation of the present subject matter.

FIG. 8 illustrates a non-transitory computer-readable medium for recommending a workflow for generating collated information record, in accordance with an example of the present subject matter.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Generally, different types of data or records may be generated or requested to provide information about different aspects related to, for example, computing environments, technological ecosystems, offerings, and the like. For example, organizations may develop one or more records that may provide different types of information about their offerings. Such records may provide, for example, information related to their products and/or services, organization's progress, internal modifications in structure or management, performance of the products and/or services, and other information or updates. Such records may be, for example, in the form of analytical reports indicating the performance of the organization's product. Other examples of such records or documents may include, but are not limited to, review reports, operational performance reports, annual product quality review (APQR) reports, Standard operating procedures (SOPs), maintenance logs, finance-related reports or statements, datasheets, manuals, project reports, catalogues, and the like. Thus, various information records may be created and maintained by organizations to provide insights about different aspects related to the products, services, platforms, or other offerings. In other examples, the records may be indicative of different aspects related to a network or a computing environment. For example, in a computing environment, a multitude of components, such as interconnected sensors, edge devices, and software applications or interfaces may generate data indicative of different aspects or parameters related to the components or the environment. The generated data or records may present an opportunity to derive information about, for example, the functioning, operations, and management of the components or the computing environment. Similarly, other examples of record or information generation may also be possible. Thus, in various scenarios, data or records may be generated that may indicate different types of information and may be leveraged for employing various data-centric approaches and deriving various insights, for instance, for decision-making processes, develop predictive maintenance strategies, and discern subtle trends or anomalies that would otherwise remain imperceptible.

Also, such records may be collection of data or content related to different topics, for example, features, modifications, characteristics, performance, results, quality, and workflows that may be associated with the products and/or services. The data may be in textual format, non-textual format, or a combination of both. For example, the records may include the content or information in different formats, text, images, tables, charts, graphs, templates, advertisements, dashboards, and a combination thereof.

Further, the records may include content that may be derived or obtained from multiple data sources. That is, in some cases, the data required to generate such information records or documents may be available with different data sources, for example, different databases, platforms, software, or tools. Further, the data available with different data sources may have non-uniform or different aspects, for example, the format or structure associated therewith. The data, in some cases, may have to be extracted, transformed, and loaded to develop such information records. Generally, different types of platforms, applications, or facilitator tools may be used for such extraction, transformation, and loading of data from the data sources. For example, such tools may facilitate the process of gathering, processing, and organizing data or information from various data sources into coherent and useful records.

In modern data processing ecosystems, the conventional approach to such data processing typically involves a comprehensive workflow designed and executed to shepherd the heterogeneous data through various processing stages. This workflow generally encompasses multiple operations, each operation being facilitated by specialized software or tools tailored to the specific requirements of the data and a desired output. For instance, data integration operations may leverage robust tools, such as Informatica®, while subsequent analytical operations might employ cloud-based query tools, such as Amazon Athena®. Further, data visualization may be accomplished through business intelligence tools such as Amazon QuickSight®. The different tools require multiple Extract Transform Load (ETL) processes to be performed, for example, for establishing coherence between the heterogeneous data from the data sources and for the generation of information records. Such ETL processes are often distributed across the entire workflow, with initial ETL processes occurring during the data integration phase, additional transformations taking place during intermediate processing steps, and even at the presentation layer where final modifications might be necessary to meet specific visualization or reporting requirements.

Further, the complexity of these data processing workflows is compounded by the diverse nature of data or data sources. These may include, for example, structured data from relational databases, semi-structured data from NoSQL databases or JSON files, and unstructured data from text documents, images, or video streams. Each data type may require, for example, specific handling and transformation techniques, adding layers of complexity to the overall data management or ETL process. Moreover, the volume, velocity, and variety of data in modern ecosystems continue to grow exponentially. The growth challenges traditional data processing architectures and necessitates the adoption of more scalable and flexible solutions.

While these software, platforms, or tools are designed to enhance productivity and data manipulation capabilities, they introduce several technical drawbacks. For example, each tool may have its own unique interface, programming language, or operational paradigm, requiring users to invest substantial time and effort to become proficient. This learning curve can be particularly steep for tools that use specialized query languages or complex configuration settings. Further, the complexity of these tools may lead to a higher likelihood of user errors, especially for those with limited expertise in specific tools. These errors can range from minor data discrepancies to major data corruption issues, potentially impacting the integrity of the entire data processing pipeline or workflow. Also, the proficiency of personnel with these tools can vary widely, even within an organization itself, leading to inconsistent data handling and analysis quality. This disparity can result in bottlenecks where certain tasks can only be performed by a limited number of expert users. For instance, a user having below par proficiency for interacting with the ETL processes in a tool may end up garbling the data and thereby causing an erroneous output to be generated by the tool. The consequences of such mismatches between user proficiency and tool complexity can be severe. Errors introduced, for example, during data transformation or analysis stages can propagate through the workflow, potentially resulting in flawed insights, inaccurate reports, or compromised decision-making processes. Further, the need for multiple ETL processes across the workflow increases the complexity of data management and the potential for data inconsistencies or errors. For example, each transformation step may introduce the risk of data loss, corruption, or misinterpretation, especially when dealing with complex data types or large volumes of data.

According to examples of the present subject matter, techniques for providing a workflow for efficient generation of collated information record are described. The techniques provide a streamlined, adaptive, and user-centric approach to workflow management in data-intensive environments, for example, by aligning the allocation of facilitator tools based on the required operations and competencies of entities.

According to one example of the present subject matter, a plurality of data descriptors may be retrieved. The plurality of data descriptors may be retrieved, in one example, by parsing a record generation query. Each of the data descriptors may indicate a parameter associated with information to be collated for servicing the record generation query. Examples of the parameter may include, but are not limited to, topic or theme, characteristics, and type of data to be collated to service or address the record generation query. Further, an interlinked operations set including one or more operations to be performed is determined for generating a collated information record using the information to be collated. The interlinked operations set is indicative of at least a sequence of execution of the one or more operations to be performed for the generation of the collated information record. In one example, the interlinked operations set may include operations related to extraction, transformation, and loading of the information to be collated to service the record generation query.

Thereafter, a facilitator tool set may be identified to perform the one or more operations of the interlinked operations set and to generate a plurality of operation-facilitator tool combinations. For example, the facilitator tool set may include a plurality of facilitator tools and each of the one or more operations is correlated with at least one of the plurality of facilitator tools, thereby forming the operation-facilitator tool combinations. That is, for each of the one or more operations, at least one facilitator tool may be configured to perform the corresponding operation. In one example, the plurality of facilitator tools may be software or applications capable of performing operations related to extraction, transformation, and loading of data.

Further, a designated competent entity, from amongst a plurality of designated competent entities, is determined for each of the plurality of operation-facilitator tool combinations. The designated competent entity may be an entity capable of executing an operation in the interlinked operations set by utilizing a facilitator tool from amongst the plurality of facilitator tools. In one example, the designated competent entity may be a proficient user expert in performing or executing an operation by utilizing a facilitator tool corresponding to that operation. Once the designated competent entity is determined, generation of a workflow signal is caused to render a recommended workflow for each designated competent entity. The recommended workflow may include, for example, for each determined designated competent entity, the operation in the interlinked operations set, the facilitator tool identified for performing the operation, and the information to be collated for servicing the record generation query. Further, the recommended workflow is executable for generation of the collated information record. In one example, the collated information record may be a document comprising data or information derived based on the information to be collated. For example, the collated information record may include information or records derived by transforming the information to be collated. Further, in one example, the operation-facilitator tool combinations for each determined designated competent entity may be generated at a time instance before the receipt of the record generation signal and rather the workflow signal is caused to be generated in response to receipt of the record generation signal.

Further, in one example of the present subject matter, one of the record generation signal and the record generation query indicates a performance metric threshold for generating the collated information record. The performance metric threshold may be indicative of, in one example, an operational target to be complied with or met in generating the collated information record. The operational target may be, for example, one of a processing time threshold, a resource utilization threshold, a cost threshold, a service level agreement (SLA) threshold, and a combination thereof. In the example, subsequent to the identification of the facilitator tool set to perform the one or more operations, an operation-facilitator tool combination corresponding to each operation in the interlinked operation set is determined based on the performance metric threshold.

The present subject matter may address the problems associated with conventional techniques and provide several significant technical advantages. For example, the present subject matter provides a streamlined, adaptive, and user-centric approach to workflow management in data-intensive environments. By determining the required operations and aligning the allocation of facilitator tools based on the required operations and competencies of entities, the workflow for processing data from the data sources is streamlined and error-resistant. That is, by recommending such a tailored workflow comprising the sequence of operations, facilitator tools to be used for each of the operations, and the designated competent entity for each of the operation-tool combination, the present subject matter provides a streamlined or guided workflow recommendation for generating the collated information record. The dynamic assignment of competent entities to specific operation-facilitator tool combinations also ensures that performance goals are met, and operational efficiency is improved. This is also advantageous in scenarios where specific performance metric thresholds, such as processing time, resource utilization, cost, or service level agreements, need to be adhered to. The ability to adapt the workflow for better alignment with these performance metric thresholds assists in consistently meet operational targets.

Further, such a tailored workflow with tool allocation significantly reduces the risk of errors that may arise from mismatches between user proficiency and tool complexity. As a result, data mishandling and misinterpretation may be reduced, thereby enhancing the overall accuracy and reliability of the generated collated information record. Furthermore, the interlinked operations set, which may include operations related to extraction, transformation, and loading of information, provides a comprehensive framework for generating collated information records. This structured approach ensures that all necessary steps are performed in the correct or desired sequence, leading to more consistent and high-quality outputs.

Further, associating or correlating operations with appropriate facilitator tools and competent entities allows for optimal resource allocation. This not only improves the speed, utilization, and accuracy of information processing but also potentially reduces operational costs by ensuring that the right tools and personnel are assigned for each operation. Additionally, the generation of a recommended workflow for each designated competent entity promotes clarity in workflow and reduces confusion in the execution of operations, leading to smoother operational processes and potentially faster turnaround times for generating collated information records.

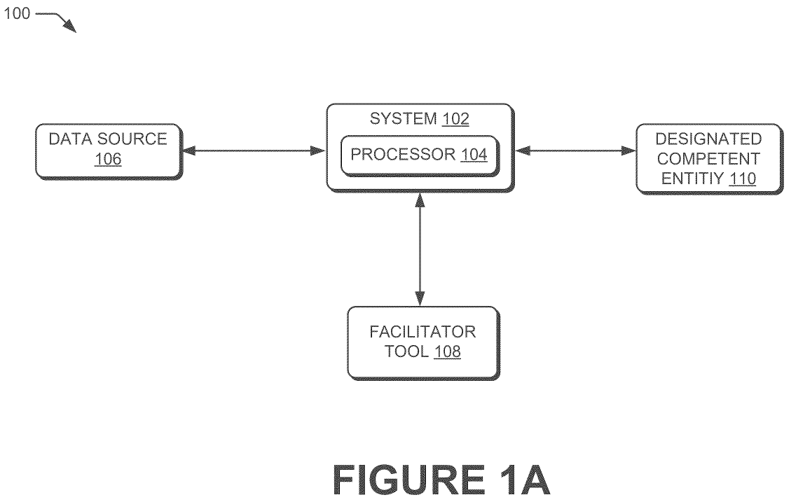

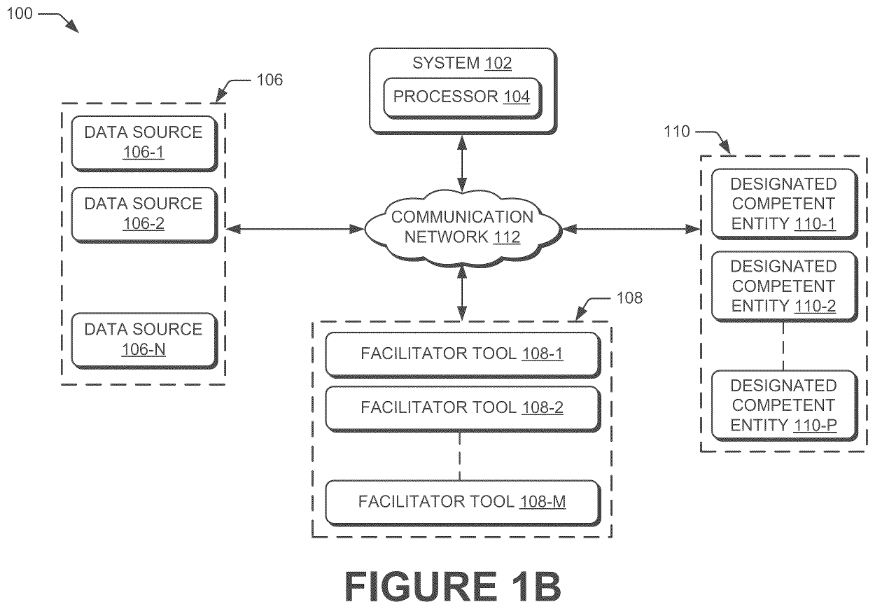

The above techniques are further described with reference to FIGS. 1A to 8. It would be noted that the description and the figures merely illustrate the principles of the present subject matter along with examples described herein and would not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIGS. 1A and 1B illustrate a block diagram of a computing environment 100, according to an example implementation of the present subject matter. FIGS. 1A and 1B may be discussed in conjunction with each other.

The computing environment 100 may be an environment having multiple entities that may be communicably coupled with each other, for instance, to exchange data, records, files, and/or signals. For example, the computing environment 100 may be a technological environment where data may be extracted from an entity, transformed, and/or loaded for another entity of the computing environment 100. In one example, the computing environment 100 may be associated with one or more organizations where multiple entities and/or computing devices may be communicably coupled with each other. In another example, the computing environment 100 may be associated with a service or platform that may be accessed by one or more users to submit queries, exchange data, and/or generate records. Similarly, other examples of the computing environment 100 may also be possible.

In one example, the computing environment 100 may include a system 102 having a processor 104, a data source 106, a facilitator tool 108, and a designated competent entity 110. The system 102, the data source 106, the facilitator tool 108, and the designated competent entity 110 may be communicably coupled with each other. The coupling may be, in one example, direct coupling, as illustrated in FIG. 1A. For example, the coupling may be wired or wireless and through one or more networking devices (not shown), such as switches, routers and/or gateways. The one or more networking devices may facilitate exchange of data, records, files, signals, and/or instructions between the system 102, the data source 106, the facilitator tool 108, and the designated competent entity 110.

In another example, the coupling may be through a communication network 112, as illustrated in FIG. 1B. The system 102, the data source 106, the facilitator tool 108, and the designated competent entity 110 may exchange data, records, files, signals, and/or instructions through the communication network 112. For instance, the system 102, the data source 106, the facilitator tool 108, and the designated competent entity 110 may be distributed across different locations and/or platforms and may be communicably coupled over the communication network 112 for inter-communications and exchange of data, records, files, signals, and/or instructions. Examples of the communication network 112 may include, but are not limited to, LAN, WAN, the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 112 may include various network devices or entities, such as transceivers, gateways, switches, and routers. In an example, the communication network 112 may include any communication network that uses any of the commonly used protocols, for example, Hypertext Transfer Protocol (HTTP), and Transmission Control Protocol/Internet Protocol (TCP/IP) In one example, the data source 106 may be a source of data or information. For example, the data source 106 may be one or more tools, applications, and/or platforms that may generate data. Examples of the application may include, but are not limited to, word processors, spreadsheets, presentation software, database management software, web browsers, email clients, graphic design software, project management tools, finance-related applications, social media applications or platforms, content delivery application or platform. In an example, the data source 106 may be one or more systems. Examples of such systems may include, but are not limited to, cloud computing systems, communication networks, content delivery networks, surveillance systems, supply chain management systems, health information systems, manufacturing execution systems, and virtual reality systems.

In an example, the data source 106 may be systems, tools, applications, and/or platforms associated with one or more organizations. Examples of such systems, tools, applications, and/or platforms may include, but are not limited to, resource planning, customer relationship management, human resource management, content management, inventory management, production management, supply chain management, data analytics, financial management, and collaboration tools.

In an example, the data source 106 may also be one or more devices or systems associated with one or more users. Examples of such devices may include, but are not limited to, computing systems, laptops, mobile phones, tablets, wearable devices, smart home devices, medical devices, and gaming consoles. In an example, the data source 106 may also be one or more systems and/or devices operationally linked with an environment. Examples of such systems and/or devices may include, but are not limited to, sensors, building management systems, control systems, and other equipment located within an enclosed environment or space.

In an example, the data source 106 may also be one or more databases. The one or more databases may be configured, in one example, to store the data generated by the systems, tools, applications, and/or platforms discussed in the above examples. In another example, the databases may be associated with one or more organizations and may include different types of data or information related thereto. Examples of such data or information may include, but are not limited to, information about their products and/or services, organization's progress, internal modifications in structure or management, performance of the products and/or services, and other information or updates. The databases may also include data or information in the form of documents, files, or reports. Examples of such reports or documents may include, but are not limited to, analytical reports, review reports, operational performance reports, APQR reports, SOPs, maintenance logs, finance-related reports or statements, datasheets, manuals, project reports, catalogues, and the like. Thus, the data source 106 may include one or more databases or datastores that may store data providing insights about different aspects related to the products, services, platforms, or other offerings. In other examples, the data source 106 may include data related to other different aspects. For example, in a computing environment, a multitude of components, such as interconnected sensors, edge devices, and software applications or interfaces may generate data indicative of different aspects or parameters related to the components or the environment. The data source 106 may include such components or the data generated by such components. Further, the data source 106 may include information that may be, for example, computer programs, data associated with one or more web pages, user or customer-related data, diagnostic reports associated with a patient, and research-related data. Similarly, other examples of information may also be possible that may be generated and/or stored in the data source 106.

Thus, the data source 106 may either be a source that may generate data or store where such data may be available. For example, the data source 106 may include systems, tools, applications, software, platforms, and/or devices; or may store the data generated by such systems, tools, applications, software, platforms, and/or devices. In one example, the data source 106 may store the data in raw form. In another example, the data may be stored as a collection, for instance, in the form of files or documents. Further, the information in the data source 106 may be in textual format, non-textual format, or a combination of both. For example, the information may be text, images, tables, charts, graphs, templates, advertisements, dashboards, and a combination thereof.

Further, the data or information available with the data source 106 may be accessible by authorized entities, for example, the processor 104, the facilitator tool 106, and the designated competent entity 110. The data source 106 may also be configured to transmit information to the authorized entities. In one example, the data available with the data source 106 may be accessed and/or processed for generating processed content. For example, the data may be retrieved, accessed, transformed, and/or collated by the authorized entities to generate processed data, also referred to as collated information records.

Further, the facilitator tool 108 may include one or more systems, tools, applications, software, platforms, and/or devices configured to assist with data processing, analysis, and/or management. In one example, the facilitator tool 108 may be capable of performing extraction, transformation, and loading operations. For example, the facilitator tool 108 may extract data from various sources, such as the data source 106, transform the data into a suitable format, and load the data. The data may be loaded, for example, in a target database, a system, or an application. Examples of the facilitator tool 108 may include, but are not limited to, an data extraction tool, data transformation tool, data loading tool, data visualization software, data integration platform, business intelligence applications, data quality and cleansing tool, data governance tool, and machine learning platform. Such facilitator tools can be used individually or in combination to support various data processing and analysis operations, for example, to derive insights and make data-driven decisions. Thus, the facilitator tool 108 may be one or more systems, tools, applications, software, platforms, and/or devices configured to perform various operations, for example, operations related to data processing, analysis, management, and manipulation.

In one example, the designated competent entity 110 may be one or more entities adept at performing one or more operations and/or using one or more facilitator tools. The designated competent entity 110, in one example, may be one or more skilled professionals having considerable expertise or experience in one or more operations and/or using one or more facilitator tools. In another example, designated competent entity 110 may be one or more trained or qualified professionals tasked with performing specific operations and/or using specific facilitator tools. Examples of such professionals may include, statisticians, financial analysts, developers, graphics designers, database experts, quality control specialists, business administrators, data analysts, and the like.

In yet another example, the designated competent entity 110 may be a resource capable of handling distinct operations and/or using one or more facilitator tools. Examples, of such resources may include, but are not limited to, systems, tools, applications, platforms, and machine learning algorithms that may be capable of performing one or more specific operations and/or using one or more facilitator tools. The designated competent entity 110 can be any competent entity capable, proficient, or designated for executing a particular segment or operation in a workflow using a designated facilitator tool. Thus, the designated competent entity 110 may be any of an individual, team, application, device, system, and/or platform that may possess the requisite skills, knowledge, and expertise to execute a specific operation and/or use a designated facilitator tool. The designated competent entity 110 may be characterized based on their, for example, proficiency, expertise, experience, efficiency, past actions or performance, reliability, and problem-solving capability. The designated competent entity 110 may be a critical component ensuring, for example, that each operation is executed with the highest level of competence and precision.

Though FIG. 1A illustrates single data source 106, the facilitator tool 108, and the designated competent entity 110 communicably coupled with the system 102, however, other architectures or arrangements may also be possible. For example, the system 102 may be communicably coupled with, as illustrated in FIG. 1B, multiple data sources, such as the data sources 106-1 to 106-N, where N is a natural number. Multiple data sources may, hereinafter, collectively be referred to as data sources 106 and individually be referred to as data source 106. In one example, each of the data sources 106 may be different sources of data. However, it may also be possible, in one example, that each of the data sources 106 may be distinct instances of the same source of data. Further, in one example, each of the data sources 106 may store distinct data. For example, each of the data sources 106 may be a database or datastore configured to store data generated by different sources of data. In yet another example, each of the data sources 106 may follow a different set of rules or guidelines based on which they may generate and/or store data. For example, the data source 106-1 may only be configured to store textual data in a specific format, whereas the data source 106-2 may be configured to store data in another format.

Further, it may also be possible, in one example, that the system 102 may be communicably coupled with multiple facilitator tools and designated competent entities, as illustrated in FIG. 1B. For example, the system 102 may be communicably coupled with facilitator tools 108-1 to 108-M and designated competent entities 110-1 to 110-P, where M and P are natural numbers. Multiple facilitator tools may, hereinafter, collectively be referred to as facilitator tools 108 and individually be referred to as facilitator tool 108. In one example, it may be possible that each of the facilitator tools 108 may either be different tools or different instances of a same tool. Further, the designated competent entities may, hereinafter, collectively be referred to as designated competent entities 110 and individually be referred to as designated competent entity 110. In one example, each of the designated competent entities 110 may be distinct from each other.

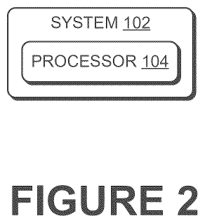

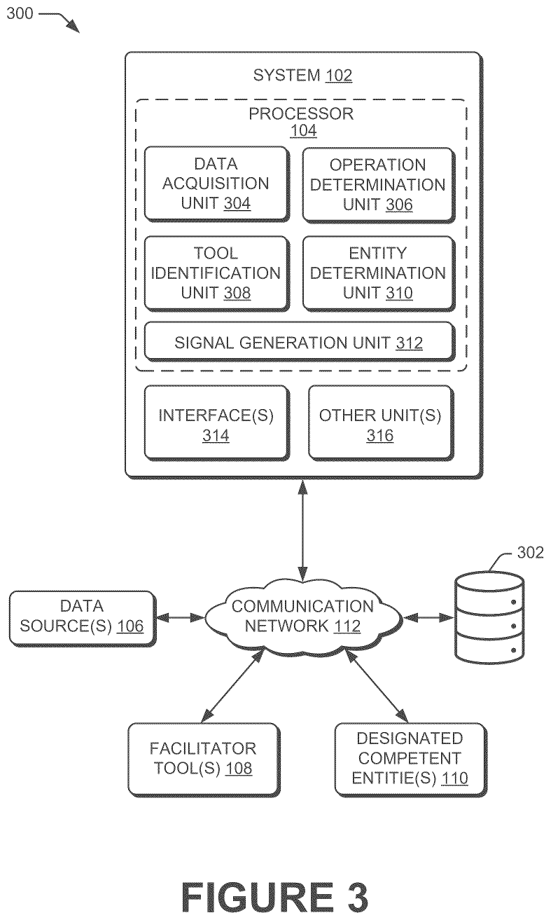

In one example, the computing environment 100 may further include the system 102 having at least the processor 104. The system 102 may be communicably coupled with the data sources 106, facilitator tools 108, and the designated competent entities 110. The system 102, in one example, may assist in the processing of data and generation of required outcomes, for instance, the collated information records. In one example, the system 102 may be configured to provide a streamlined, adaptive, and user-centric approach to workflow management in data-intensive environments, such as the computing environment 100. For example, the system 102 may be configured to determine the required operations and align the allocation of facilitator tools 108 based on the required operations and competencies of entities 110. The system 102 may accordingly recommend one or more workflows that may assist in generation of one or more collated information records. To elaborate on the functionality of the system 102, reference is made to FIGS. 2 and 3.

In one example, the system 102 may be implemented as a set of one or more hardware devices or modules. For example, the system 102 may be implemented as a set of one or more hardware devices, comprising the processor 104. In this example, the set of one or more hardware devices may be communicably coupled with the communication network 112, and/or the data sources 106, the facilitator tools 108, and the designated competent entities 110. Examples of the set of one or more hardware devices may include, but are not limited to, servers, computing systems, gateways, access points, and network nodes or networking devices. In another example, the system 102 may be implemented as a set of computer-executable instructions. Examples of the system 102, according to this example, may include, but are not limited to, software applications, cloud-based platforms, platforms hosted or accessible via the internet, virtual gateways, firewalls, data pre-processors, Platform as a Service (PaaS), and Software as a Service (SaaS). In yet another example, the system 102 may be implemented as a combination of the one or more hardware devices and the set of computer-executable instructions.

Further, though illustrated in FIGS. 1A and 1B that the data sources 106, the the facilitator tools 108, and the designated competent entities 110 are communicably coupled with the system 102 and are external to the system 102, however, other architectures and implementations may also be possible. In one example, the data sources 106, the facilitator tools 108, and the designated competent entities 110 may be a part of the system 102 (not shown). In this example, the data sources 106, the facilitator tools 108, and the destination 110 may be communicably coupled with, or via, the processor 104. Different architectures and examples have been discussed above. However, such examples and illustrations are not to be considered as limiting in scope and nature. Other obvious architectures and examples of the data sources 106, the facilitator tools 108, and the designated competent entities 110 may also be possible.

FIG. 2 illustrates a block diagram of the system 102, according to one example implementation of the present subject matter. FIG. 2 will be discussed in conjunction with FIGS. 1A and 1B. In one example, the system 102, having the processor 104, may facilitate in generation of a workflow to generate collated information record.

In one example operation, the processor 104 may retrieve one or more data descriptors by parsing a record generation query. The processor 104 may retrieve the one or more data descriptors, in one example, in response to receipt of a record generation signal. Further, each of the one or more data descriptors may indicate a parameter associated with information to be collated for servicing the record generation query.

Further, the processor 104 may determine an interlinked operations set comprising one or more operations to be performed for generating a collated information record using the information to be collated. The interlinked operations set may be indicative of at least a sequence of execution of the one or more operations to be performed for the generation of the collated information record. Thereafter, the processor 104 may identify a facilitator tool set to perform the one or more operations of the interlinked operations set and to generate a plurality of operation-facilitator tool combinations. In one example, the facilitator tool set may comprise a plurality of facilitator tools, such as the facilitator tools 108, and each of the one or more operations may be correlated with at least one facilitator tool in each of the plurality of operation-facilitator tool combinations.

The processor 104 may then determine a designated competent entity, from amongst a plurality of designated competent entities 110 and for each of the plurality of operation-facilitator tool combinations. The designated competent entity 110, in one example, may be an entity capable of executing an operation in the interlinked operations set by utilizing a facilitator tool from amongst the plurality of facilitator tools 108. Once the designated competent entity 110 is determined, the processor 104 may cause generation of a workflow signal to render a recommended workflow for each designated competent entity 110. The recommended workflow may include, in one example, for each determined designated competent entity 110, the operation in the interlinked operations set, the facilitator tool 108 identified for performing the operation, and the information to be collated for servicing the record generation query.

The present subject matter offers significant technical advantages for workflow management in data-intensive environments. For example, by tailoring the workflow and tool allocation to the competencies of entities, the risk of errors stemming from mismatches between entity proficiency and tool complexity may be reduced. Thus, the present subject matter minimizes data mishandling and misinterpretation, thereby enhancing the overall accuracy and reliability of the generated collated information record. Accordingly, the present subject matter allows dynamic assignment of competent entities to specific operation-facilitator tool combinations ensuring improved operational efficiency with reduced errors. Additionally, the interlinked operations set provides a comprehensive framework for generating collated information records, leading to more consistent and high-quality outputs. This approach optimizes resource allocation, improves processing speed and accuracy, potentially reduces costs, and promotes clarity in workflow execution.

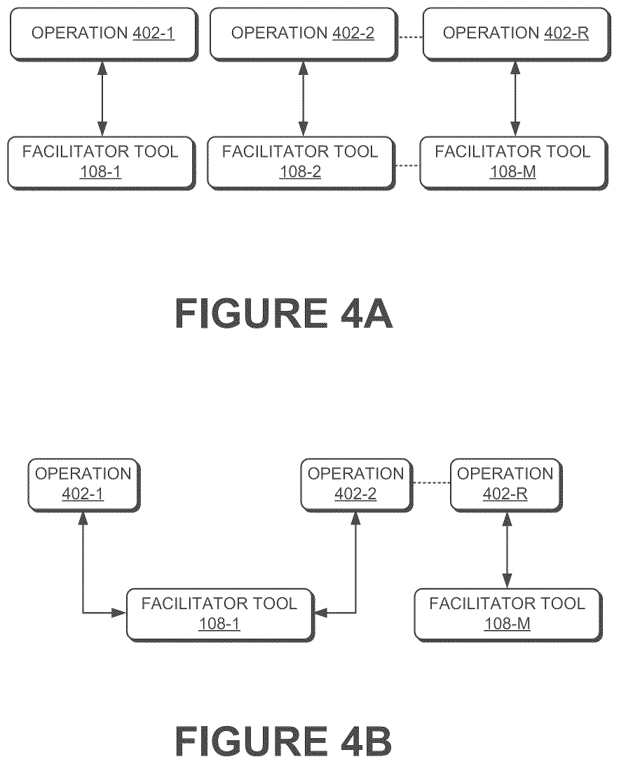

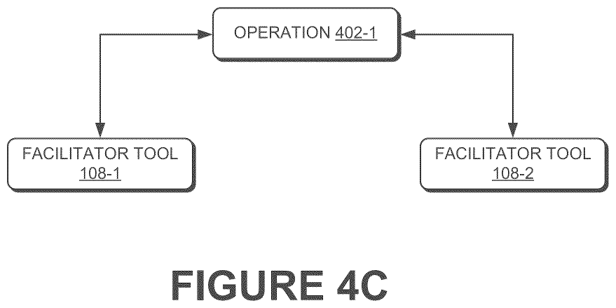

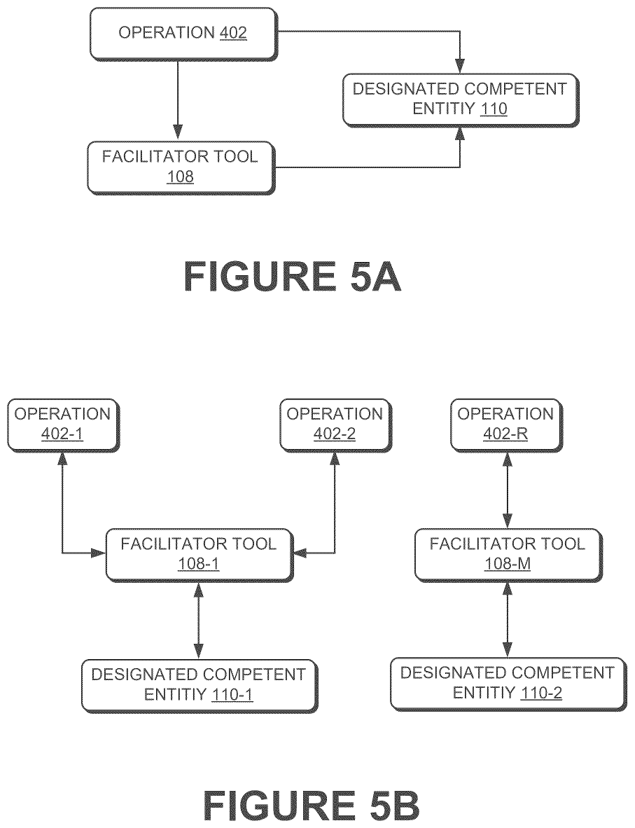

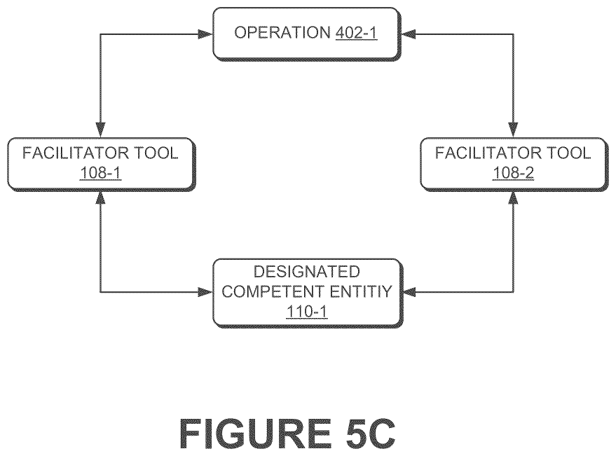

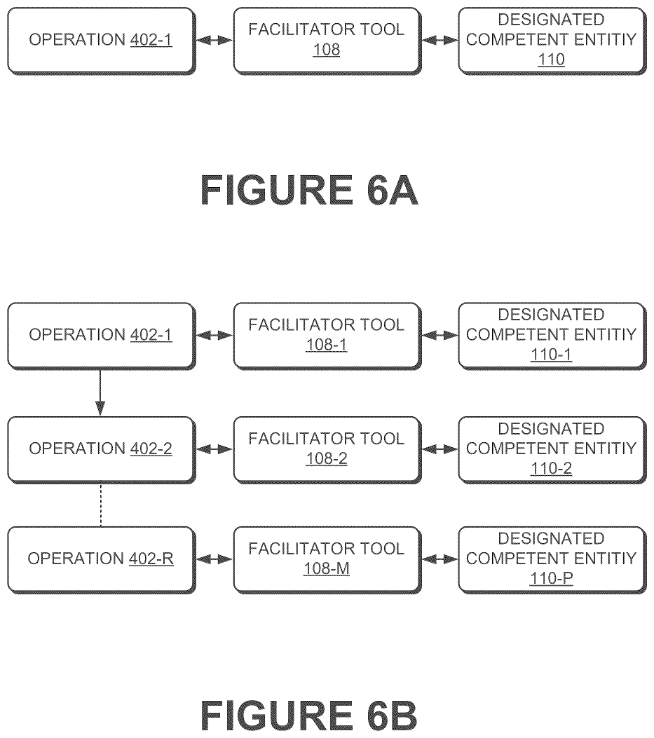

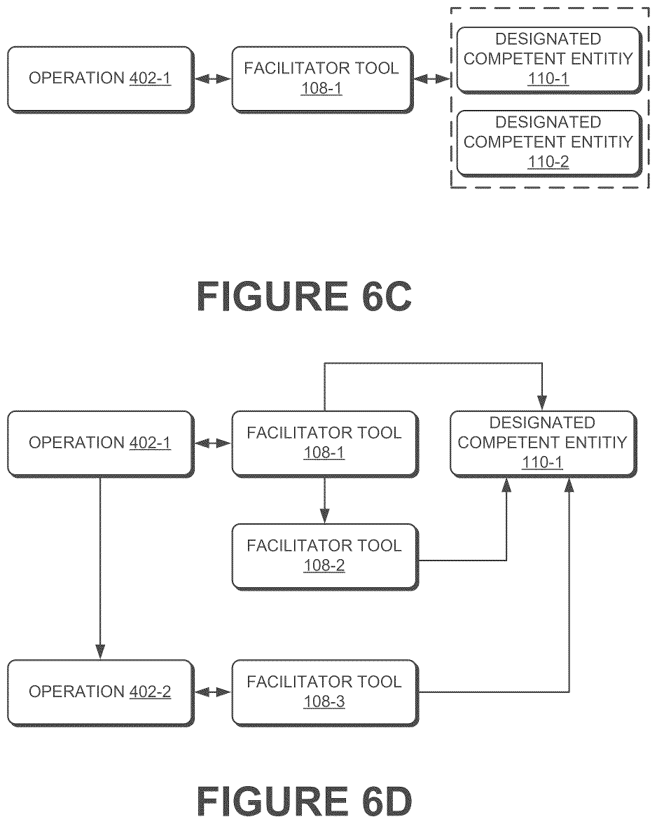

FIG. 3 illustrates a block diagram of a computing environment 300 comprising the system 102, according to another example implementation of the present subject matter. FIG. 3 will be discussed in conjunction with FIGS. 1A and 1B and the subject matter disclosed therewith shall be incorporated herein for reference, for the sake of brevity. FIG. 3 will also be discussed in conjunction with FIGS. 4A to 6D. FIGS. 4A to 4C illustrate block diagrams of a few exemplary operation-tool combinations, according to one example implementation of the present subject matter. FIGS. 5A to 5C illustrate block diagrams of few exemplary combinations of one or more designated competent entities with the operation-tool combinations, according to one example implementation of the present subject matter. FIGS. 6A to 6D illustrate block diagrams of few exemplary workflows, according to one example implementation of the present subject matter.

In one example, the computing environment 300 may be similar to the computing environment 100, as discussed in reference to FIGS. 1A and 1B. The computing environment 300 may be any environment having the system 102, the data source(s) 106, the facilitator tool(s) 108, the designated competent entity(s) 110, and one or more data stores 302 communicably coupled with each other either directly or through the communication network 112. The computing environment 300 may thus be a network of such entities that may be communicably coupled with each other, for example, over the communication network 112. Further, as discussed above, multiple data sources may be collectively referred to as data sources 106 and individually be referred to as data source 106; multiple data sources may be collectively referred to as facilitator tools 108 and individually be referred to as facilitator tool 108; and multiple data sources may be collectively referred to as designated competent entities 110 and individually be referred to as designated competent entity 110.

The computing environment 300 may include the system 102, in one example, communicably coupled with the data source(s) 106, facilitator tool(s) 108, and the designated competent entity(s) 110. The system 102, in one example, may assist in the processing of data and generation of the collated information records. In one example, the system 102 may be configured to provide a streamlined, adaptive, and user-centric approach to workflow management in data-intensive environments, such as the computing environment 300. For example, the system 102 may be configured to determine the required operations and align the allocation of facilitator tools 108 based on the required operations and competencies of entities 110. The system 102 may accordingly recommend one or more workflows that may assist in generation of one or more collated information records. The system 102 may be configured to recommend a tailored workflow comprising the sequence of operations, facilitator tools 108 to be used for each of the operations, and one or more designated competent entities 110 for each of the operation-tool combination.

In one example, the system 102 comprises the processor 104. The processor 104 may be implemented as a dedicated processor, a shared processor, or a plurality of individual processors, some of which may be shared. Examples of the processor 104 may include, but are not limited to, microprocessors, microcomputers, microcontrollers, digital signal processors, central processing units, state machines, Artificial Intelligence (AI) based processors, machine learning-based processors, deep learning-based processors, system on chip (SOC), processing circuitries including one or more modules or engines, and/or any other devices that manipulate signals and data based on computer-readable instructions, and/or any other devices.

In one example, the processor 104 may include one or more sub-processing units or engines. For example, the processor 104 may include a data acquisition unit 304, an operation determination unit 306, a tool identification unit 308, an entity determination unit 310, and a signal generation unit 312. The units may be implemented as a combination of hardware and programming, for example, programmable instructions to implement a variety of functionalities of the units. In examples described herein, such combinations of hardware and programming may be implemented in several different ways. For example, the programming for the units or engines may be executable instructions. Such instructions in turn may be stored on a non-transitory machine-readable storage medium which may be coupled with the system 102 either directly or indirectly (for example, through networked means). In an example, it may also be possible that each of the units or engines includes a processing resource, for example, a single processor or a combination of multiple processors, to execute such instructions. In one example, such instructions may be stored in a memory of other unit(s) 316 of the system 102. In other examples, the units or engines may be implemented as electronic circuitry.

The system 102 may further comprise, in one example, interface(s) 314. The interface(s) 314 may include a variety of software and hardware interfaces that allow interaction of the system 102 with other communication and computing devices, such as network entities, web servers, external repositories, and peripheral devices, such as input/output (I/O) devices. For example, the interface(s) 314 may communicably couple the system 102 with the data source(s) 106, facilitator tool(s) 108, and the designated competent entity(s) 110. The interface(s) 314 may also enable the coupling of internal components of the system 102 with each other.

The system 102 may further comprise, in one example, the other unit(s) 316. The other unit(s) 316 may include, in one example, a power supply unit, a communication unit, and the memory. The power supply unit may, for example, manage distribution or supply of electrical current within the system 102 for functioning of the system 102. Further, the communication unit may be, in one example, a wireless communication unit. Examples of the communication unit may include, but are not limited to, Global System for Mobile communication (GSM) modules, Code-division multiple access (CDMA) modules, Bluetooth modules, network interface cards (NIC), Wi-Fi modules, dial-up modules, Integrated Services Digital Network (ISDN) modules, Digital Subscriber Line (DSL) modules, and cable modules. In one example, the communication unit may also include one or more antennas to enable wireless transmission and reception of data and signals. The communication unit may allow the system 102 to be communicably coupled with data source(s) 106, facilitator tool(s) 108, and the designated competent entity(s) 110, and/or the communication network 112. Also, the communication unit may allow the system 102 to transmit and receive data, files, and/or signals.

Further, the memory may include any computer-readable medium known in the art including, for example, volatile memory, such as Static Random-Access Memory (SRAM) and Dynamic Random-Access Memory (DRAM), and/or non-volatile memory, such as Read Only Memory (ROM), Erasable Programmable ROMs (EPROMs), flash memories, hard disks, optical disks, and magnetic tapes. In one example, the memory may store the data received, processed, or generated by the system 102 and/or the processor 104.

The computing environment 300 may further comprise, in one example, the one or more data stores 302. Further, the one or more data stores 302 may include, for example, a set of storage devices capable of storing data and information, for instance, one or more sample or previously generated files or records that may assist in the generation of one or more workflows. The set of storage devices may be virtual storage devices, physical storage devices, a cloud-based storage service, or a combination thereof. For example, the one or more data stores 302 may be any repository or storage unit implemented by physical, logical, and/or virtual storage devices. In one example, the one or more data stores 302 may include a set of physical storage devices. In another example, the one or more data stores 302 may include virtual storage devices being implemented on physical storage devices. In another example, the one or more data stores 302 may include one or more physical or logical storage units that may either be located at the same location or distributed geographically. In another example, the one or more data stores 302 may be implemented over a cloud-based storage service.

Further, the one or more sample or previously generated files or records, in one example, may be previously generated or collated data, records, and/or documents generated by the one or more designated competent entities, and may hereinafter, collectively and individually, be referred to as a historical collated information record. Examples of such historical collated information record may include, but are not limited to, analytical data, review reports, annual product quality review (APQR) reports, finance-related statements, sales reports, datasheets, FDA reports, manuals, catalogues, editable computer-readable files, drawings, graphs, sample data, and the like.

Further, the one or more data stores 302, in one example, may also store a contextual information element associated with each historical collated information record. The contextual information element may be, for example, data or information indicating the facilitator tools 108 used by each of the one or more designated competent entities 110 for each operation performed in generation of the historical collated information record. In one example, the contextual information element may also indicate different parameters about information or data embedded in, or associated with, the historical collated information record. Such parameters may indicate, for example, theme or topic, characteristics, nature, format, structure, and type of information or data. For example, the parameters may indicate whether the information or data embedded in, or associated with, the historical collated information record is numeric, statistical, graphical, alphabetic, alphanumeric, or of another type.

In one example, the contextual information element may be indicative of a matrix or mapping between parameters, operations, the facilitator tools used to perform the operations, and the one or more designated entities 110 that utilized the one or more facilitator tools 108 for generating the historical collated information, or at least a portion of the historical collated information record. For example, the mapping may indicate the one or more operations performed to generate or collate data or records having a particular parameter, the one or more facilitator tools 108 used to perform the one or more operations, and the one or more designated entities 110 that utilized the one or more facilitator tools 108 and performed the one or more operations for generating the collated data or record, i.e., the historical collated information record.

In one example, such a mapping may be generated or determined by parsing one or more historical collated information records and/or the contextual information element associated with the one or more historical collated information records. In one example, the processor 104 may perform the parsing to determine or generate such mapping. In another example, the processor 104 may utilize any trained model to perform the parsing and generate such mappings. Examples of such models may include, but are not limited to, machine learning models, artificial neural networks, deep learning models. By parsing, the processor 104 may develop a context or logical relation between the one or more operations that may be performed in order to generate or collate data or records having particular parameters, the one or more facilitator tools 108 used to perform such operations, and the designated entities 110 preferred or suitable for utilizing the facilitator tools 108 and perform the operations for generating the collated data or record. The mappings, in one example, may thus be indicative of workflows followed for generation of such historical collated information records. The mappings may also indicate, in one example, a causal relationship between the one or more operations. In one example, the mappings may also indicate a data source, such as the data sources 106, from where information collated in such historical collated information records may have been derived.

In one example, the one or more historical collated information records and/or the contextual information records associated therewith may either be obtained or accessed by the processor 104 from the one or more data stores 302. In one example, the one or more historical collated information records and/or the contextual information records may have been previously generated by the one or more designated competent entities 110 and may be stored on the one or more data stores 302. In another example, the one or more historical collated information records and/or the contextual information records may be received or provided to the one or more data stores 302, and/or to the processor 104, in form of sample data, training data, or as configuration data for being analysed, processed, and develop such logics interrelationships or mappings. In one example, such data may be received via a graphical user interface, rendering of which may be caused by the processor 104. In another examples, such data may be received by the processor 104, and/or the one or more data stores 302, through one or more software, tools, or other platforms. Such data, in one example, may be submitted by one or more users. Examples of such users may include, but are not limited to, individual users, business administrators, analysts, designers, and engineers.

In one example, obtaining and parsing the one or more historical collated information records and/or the contextual information records may be a step that may be performed by the processor 104 once in the process of generation of a workflow for generating collated information record. In another example, it may be an initial step that may be performed once before subsequent generation of workflows is initiated, until another/new historical collated information record and/or the contextual information record is available or provided to at least one of the processor 104 and the data stores 302; or any instructions to use another historical collated information record and/or the contextual information record is provided by one or more users, for instance, from one or more user devices, graphical user interfaces, software, application, or other platforms.

In one example operation, the processor 104, or the data acquisition unit 304, may retrieve one or more data descriptors by parsing a record generation query. The one or more descriptors may indicate a parameter associated with information to be collated for servicing the record generation query. The processor 104 may retrieve the one or more data descriptors, in one example, in response to receipt of a record generation signal. In one example, the record generation signal may include the record generation query. The record generation signal may be triggered, in one example, on the elapse of a predefined time period. In one example, the predefined time period may be defined by one or more users for triggering of the record generation signal to cause generation of record generation query. For example, such triggering may facilitate in generation of the query, and thereby the workflow for collated information record at predefined intervals. Such implementations may help in scenarios where regular generation or records may be required, such as for monitoring purposes. In another example, the record generation signal may be triggered on user input. The user input may be, in one example, a query received from a user. The query may be received, for example, through one or more graphical user interfaces, applications, web pages, tools, platforms, user devices, and the like. In one example, the query may itself be the record generation query.

Upon receipt of at least one of the record generation signal and/or the record generation query, the processor 104 may parse the record generation query. By parsing the record generation query, the processor 104 may analyse and understand the query requesting the information to be collated. Based on its understanding of the query, the processor 104 may identify what specific information needs to be gathered and compiled to service the query. Further, the processor 104 may parse the record generation query to retrieve the one or more data descriptors from the record generation query. Each of the one or more data descriptors may indicate the parameter associated with information to be collated for servicing the record generation query. For example, the record generation query may indicate that data or a record comprising a graph indicating information about sales is to be generated or collated. The processor 104 may parse such a query and retrieve the one or more descriptors. Examples of the one or more descriptors may include, but are not limited to, theme, topic, tags, labels, characteristics, type of data, and other identifying information. For example, from the above example of the query, the processor 104 may derive that the information to be collated may be sales data and the one or more descriptors as graph. In one example, the processor 104 may utilize a Large Language Model (LLM) to parse the record generation query, determine the information to be collated, and retrieve the one or more descriptors associated with the information to be collated for servicing the record generation query. Further, in one example, the information to be collated may be data obtained from one or more of the data sources 106 based on the one or more data descriptors retrieved from the record generation query.

Further, the processor 104, or the operation determination unit 306, may determine an interlinked operations set including one or more operations to be performed for generating a collated information record using the information to be collated. In one example, the processor 104 may determine the interlinked operations set, having the one or more operations, based on at least one of the information to be collated and the one or more data descriptors. The processor 104, in one example, may refer to the mappings or matrix developed based on the historical collated information record and/or the contextual information element, as discussed above, to determine the one or more operations. For example, the processor 104 may utilize such mappings to determine the one or more operations that were performed to generate the historical collated information record comprising information similar to the information to be collated for servicing the record generation query. For example, the processor 104 may refer to the mappings indicating the one or more operations that were performed or executed for generating the historical collated information record comprising information that may be semantically similar to the information to be collated. Considering the above-discussed example of the record generation query, the processor 104 may utilize the mappings created for historical collated information record(s) that may include data associated with sales. From such mappings, the processor 104 may determine the one or more steps that were performed for generation of such historical collated information record(s). In one example, the steps performed for the highest number of times or the most common steps, performed for the generation of such historical collated information record(s), may be selected for the interlinked operations set. Considering the above-discussed example of the record generation query, the processor 104 may determine that the one or more operations may include, retrieval of sales data from a particular data source (such as the data source 106), statistical processing of the retrieved data to generate the graph, transformation of the statistically processed data, and generation of a visualization or interface indicating the graph.

In one example, the interlinked operations set may be indicative of at least a sequence of execution of the one or more operations to be performed for generation of the collated information record. The sequence of execution of the one or more operations may be determined, in one example, based on the mappings discussed above. In another example, the processor 104 may determine the sequence based on the causal relationship between the one or more operations in the interlinked set of operations. Causal relationships between multiple operations may refer to how one operation influences or depends on another. This concept can be used to determine the sequence of operations. For example, the sequence may depend upon dependency of one operation on another. For instance, operations that produce outputs necessary for subsequent operations may be executed before, followed by the subsequent operations. Other factors for determining the sequence of execution of the one or more operations may include, but are not limited to, precedence of one operation over the other, conditional execution (certain operations should only be performed based on the outcomes of previous operations), resource allocation (operations based on the availability of required resources), data flow analysis (indicating how information moves between operations to optimize the sequence), and the like. By analysing such causal relationships, the processor 104 may construct an optimal sequence of execution for operations that may ensure logical flow, efficiency, and correctness in the generation of the collated information record.

Once the interlinked operations set is determined, the processor 104, or the tool identification unit 308, may identify a facilitator tool set to perform the one or more operations of the interlinked operations set. The facilitator tool set may include a plurality of facilitator tools, such as the facilitator tools 108, and each of the one or more operations may be correlated with at least one of the plurality of facilitator tools 108. That is, the processor 104 may determine the set of interlinked operations and then identify the group of facilitator tools capable of performing the operations, where each operation within the interlinked set is associated with at least one of the facilitator tools 108. Such a process may help in ensuring that appropriate tools are selected to efficiently carry out the required operations.

In one example, the processor 104 may utilize the mappings, discussed above, to determine the facilitator tools that were utilized for performing the one or more operations involved in generation of the historical collated information record. For example, the processor 104 may utilize the mappings to determine the facilitator tools that were utilized for performing the one or more operations involved in generation of the historical collated information record that may have semantically similar information as compared to the information to be collated, for generating the collated record information. For instance, the processor 104 may utilize the mappings associated with historical collated information records comprising data related to sales and graphs.

In another example, instead of using the mappings, the processor 104 may obtain a historical collated information record generated or submitted by the one or more designated competent entities 110 and a contextual information element associated with the historical collated information record. In one example, the historical collated information record may include data semantically similar to the information to be collated for servicing the record generation query. Further, the contextual information element may indicate, in one example, the facilitator tools 108 used by each of the one or more designated competent entities 110 for each operation performed in generation of the historical collated information record. The processor 104, may parse the historical collated information record and/or the contextual information element to determine a proficiency score for each of the facilitator tools. The proficiency score may be determined based on, for example, a rating of the facilitator tools 108, a number of times the facilitator tools 108 were used for performing each of the operations, accuracy ratings of the facilitator tools 108, and the like. Based on the proficiency score, the processor 104 may select a facilitator tool from amongst the facilitator tools 108 for each of the operations. In one example, the facilitator tool having the proficiency score greater than a proficiency threshold may be selected by the processor 104. Thus, in one example, for each of the operations, the processor 104 may select a facilitator tool based on their corresponding proficiency score.

Further, as one or more facilitator tools 108 may be identified for each of the operations in the interlinked operations set, a plurality of operation-facilitator tool combinations may be generated. FIGS. 4A to 4C illustrate a few exemplary operation-tool combinations. In one example, a facilitator tool may be correlated with each of the operations in the set of interlinked operations. For example, each of the operations 402-1 to 402-R, where R is a natural number, may have a corresponding identified facilitator tool 108, as illustrated in FIG. 4A. In another example, it may also be possible that a facilitator tool may be correlated with more than one operation, as illustrated in FIG. 4B. In yet another example, it may also be possible that more than one facilitator tool 108 may be correlated with an operation, as illustrated in FIG. 4C. Similarly, different associations or correlations between the operations and facilitator tools 108 may be possible for generating multiple operation-facilitator tool combinations. That is, each of the operations in the interlinked operations set may have at least one facilitator tool 108 correlated therewith.

In one example, the facilitator tools 108, as discussed above, may include one or more systems, tools, applications, software, platforms, and/or devices. In one example, the facilitator tools 108 may be applications capable of performing data extraction operations, data transformation operations, and data loading operations. As an example, one of the facilitator tools 108 may be an application capable of transforming schematics of data or data objects within the information to be collated, for ensuring schematic compliance of the data objects with an operational routine of the facilitator tools 108. The facilitator tool 108 may include, for example, a transformative unit executable for transforming a plurality of data objects in the information to be collated. The transformation may be, for example, for schematic compliance of the plurality of data objects with an operational routine of the plurality of facilitator tools 108. In one example, the operational routine may be a predefined set of actions performed to generate an output of at least one of the one or more operations in the interlinked set of operations. For example, the transformative unit may identify a source schema for the plurality of data objects. The source schema may be indicative of a format of the plurality of data objects retrieved from a data source, such as the data source 106, generating data objects pertinent to the information to be collated. The transformative unit may access the source schema to determine one or more transformation actions to be performed on the plurality of data objects for converting the plurality of data objects from a source schema to a target schema. The target schema may be in schematic compliance with the operational routine.

To illustrate this process, consider an exemplary scenario where the transformative unit identifies a source schema for a set of data objects. This source schema indicates the format of the data objects as they are retrieved from the data source 106, which generates data objects relevant to the information to be collated for addressing the record generation query. The transformative unit may then access this source schema to determine the necessary transformation actions required to convert the data objects from their source schema to a target schema. For example, sales data (i.e., the information to be collated) may be received from various data sources 106 in different formats. The source schema might be, for example, a CSV file with columns for “Product” and “Amount”. However, the operational routine requires this data in a specific XML format with tags for “ProductName” and “FinalAmount”. The transformative unit may identify this discrepancy and perform the necessary transformations to convert the data from the CSV format (source schema) to the required XML format (target schema). Such a process may ensure that the data objects are in schematic compliance with the operational routine of the facilitator tools 108, allowing for seamless processing, avoiding data mishandling and misinterpretation, and utilization of the data in subsequent operations. By standardizing the data format, the facilitator tools 108 may more efficiently analyse, manipulate, and derive insights from the collected information, ultimately enhancing the overall data management and decision-making process.

Further, once the facilitator tool set is identified and the plurality of operation-facilitator tool combinations have been generated, the processor 104, or the entity determination unit 310, may determine a designated competent entity from amongst the plurality of designated competent entities 110 for each of the operation-facilitator tool combinations. In one example, the designated competent entity 110 may be capable of executing an operation in the interlinked operations set. For example, for each of the operations in the interlinked set of operations, where each operation has at least one facilitator tool correlated therewith, the processor 104 may determine a designated competent entity 110 for that operation. Similarly, the processor 104 may determine a designated competent entity 110 for each operation-facilitator tool pair. FIGS. 5A to 5C illustrate a few examples of such combinations of the one or more designated competent entities 110 with the operation-facilitator tool combinations. In one example, a designated competent entity 110 may be determined to be capable of performing an operation 402 by using the facilitator tool 108, as illustrated in FIG. 5A. In another example, it may also be possible that a designated competent entity 110 may be determined for performing more than one operation using a facilitator tool, as illustrated in FIG. 5B. For example, a designated competent entity 110-1 may be determined to be capable of performing operations 402-1 and 402-2 by using the facilitator tool 108-1 and another designated competent entity 110-2 may be capable of performing operation 402-R by using the facilitator tool 108-M. In yet another example, it may also be possible that a designated competent entity 110 may be determined for performing an operation using more than one facilitator tool, as indicated in FIG. 5C. In yet another example, it may also be possible that more than one designated competent entity 110 is determined to perform one or more operations using one or more facilitator tools 108 (not shown). Similarly, other associations between the designated competent entities 110, the operations 402, and the facilitator tools 108 may be possible, though not illustrated.

In one example, the designated competent entity, from amongst the plurality of designated competent entities 110, may be determined based on the mappings discussed above. In another example, the designated competent entity 110 may be determined based on at least one of the historical collated information record(s) and the contextual information element. For example, by parsing at least one of the historical collated information records and the contextual information element, the processor 104 may determine the one or more designated competent entities 110 that may have previously executed the one or more operations by utilizing a corresponding facilitator tool for generating similar collated information records (i.e., the historical collated information record). The processor 104 may select such designated competent entities 110.

In another example, the determination of the designated competent entity, from amongst the plurality of designated competent entities 110, may be based on an entity proficiency indicator associated with each of the plurality of designated competent entities 110 for a facilitator tool. For example, each of the plurality of designated competent entities 110 may have an entity proficiency indicator associated therewith for a facilitator tool. For instance, the designated competent entity 110-1 may have an entity proficiency indicator for a facilitator tool 108-1. In another example, the designated competent entity 110-1 may have an entity proficiency indicator for more than one facilitator tool, for instance, an entity proficiency indicator for facilitator tool 108-1 and another entity proficiency indicator for facilitator tool 108-2.

In one example, the entity proficiency indicator may indicate the capability or ability of a designated competent entity in performing an operation and utilizing a facilitator tool for performing that operation. The entity proficiency indicator may comprise, in one example, a positive indicator and a negative indicator. For the designated competent entity 110 having the negative indicator, the processor 104 may determine that that designated competent entity 110 may not be capable of performing the operation and utilizing the facilitator tool 108. The processor 104 may thus not determine such designated competent entity 110 for performing the operation and utilizing the facilitator tool 108 for performing that operation. In one example, the processor 104 may restrict such designated competent entity 110 from utilizing or accessing that facilitator tool 108. However, for the designated competent entity 110 having the positive indicator, the processor 104 may determine that that designated competent entity 110 may be capable of performing the operation and utilizing the facilitator tool 108 for performing that operation. The processor 104 may thus determine such designated competent entity 110 for performing the operation and utilizing the facilitator tool 108 for performing that operation. In one example, the processor 104 may allow access or utilization of the facilitator tool 108 to that designated competent entity for performing the operation.

Further, the entity proficiency indicator may be determined by the processor 104, or the entity determination unit 310, based on information received from a training management module (not shown), in one example. The training management module, in one example, may comprise records of training provided to the designated competent entities in relation to the plurality of facilitator tools 108. For example, based on training received by the designated competent entities 110 for the facilitator tools, each of the designated competent entities 110 may have the entity proficiency indicator associated therewith for each of the facilitator tools. For example, a designated competent entity 110-1 received training for a facilitator tool 108-1, the designated competent entity 110-1 may have the positive indicator associated with them for the facilitator tool 108-1, but a negative indicator for another facilitator tool 108-2 since the designated competent entity 110-1 did not receive training for the facilitator tool 108-2. The designated competent entities 110 having a positive indicator may be provided preference in selection over the designated competent entities having a negative indicator. Thus, each of the designated entities 110 may have the entity proficiency indicator associated therewith for each of the facilitator tools 108. In one example, the entity proficiency indicator for the designated competent entities 110 may be stored in the one or more data stores 302, and the processor 104 may assess the entity proficiency indicator for the designated competent entities 110 from the one or more data stores 302. Further, other criteria may also be possible for the selection of designated competent entities 110 for performing an operation and utilizing a facilitator tool. The other criteria may be, for example, experience, skillset, past performance of operations, past utilizing of facilitator tools, accuracy, and efficiency of performance of the designated competent entities.

Once the designated competent entity 110 is determined, the processor 104, or the signal generation unit 312, may cause generation of a workflow signal to render a recommended workflow for each determined designated competent entity 110. The recommended workflow may comprise, for each determined competent entity 110, the operation in the interlinked operations set, the facilitator tool identified for performing the operation, and information to be collated for servicing the record generation query. The recommended workflow may be a comprehensive guide that may outline several key elements for each determined competent entity 110. For example, the workflow may include the specific operation that needs to be performed within the interlinked operations set. This may ensure that each designated competent entity knows exactly what operation they have to perform in the overall workflow. The workflow may also identify the facilitator tool 108 that has been identified or selected for carrying out that operation. The workflow may also provide details about the information that needs to be collated or gathered from the data sources 106 and applied with the operation to effectively service the record generation query. This information may be crucial for ensuring that the designated competent entity has at least the necessary data to complete the assigned operation accurately, efficiently, and in less time. Similarly, there may be multiple designated competent entities, and one or more operations and tools being indicated in the workflow. FIGS. 6A to 6D illustrate block diagrams of a few exemplary workflows. For example, a workflow may indicate that a specific designated competent entity 110 may perform the operation 402-1 by utilizing the facilitator tool 108, as illustrated in FIG. 6A. In another example, the workflow may indicate multiple steps, where each designated competent entity 110 may have to perform a specific operation by utilizing a specific facilitator tool 108, as illustrated in FIG. 6B. In another example, it may also be possible that more than one designated competent entity has to perform an operation 402-1 by utilizing the facilitator tool 108-1, as illustrated in FIG. 6C. In yet another example, it may also be possible that a designated competent entity 110-1 has to perform an operation 402-1 by sequentially utilizing the facilitator tools 108-1 and 108-2; and another subsequent operation 402-2 by utilizing a facilitator tool 108-3, as illustrated in FIG. 6D. Similarly, different workflows may be possible, indicating the one or more designated entities and the operations and tools for the one or more designated competent entities 110.

Further, in one example, the workflow signal may be an instruction or command that may cause rendering of the recommended workflow. The workflow may be rendered, for example, on any graphical user interface, system, device, application, or platform that may be communicably coupled with the processor 104 or the system 102. In one example, the designated competent entities 110 may be able to view such recommended workflow being rendered, to initiate execution of the workflow for generation of the collated information record. The collated information record may be the outcome of the execution of the recommended workflow. For instance, considering the above example, the collated information record may be the graph indicating sales. The collated information record can also be in different forms, for example, in the form of processed data, files, documents, or records.

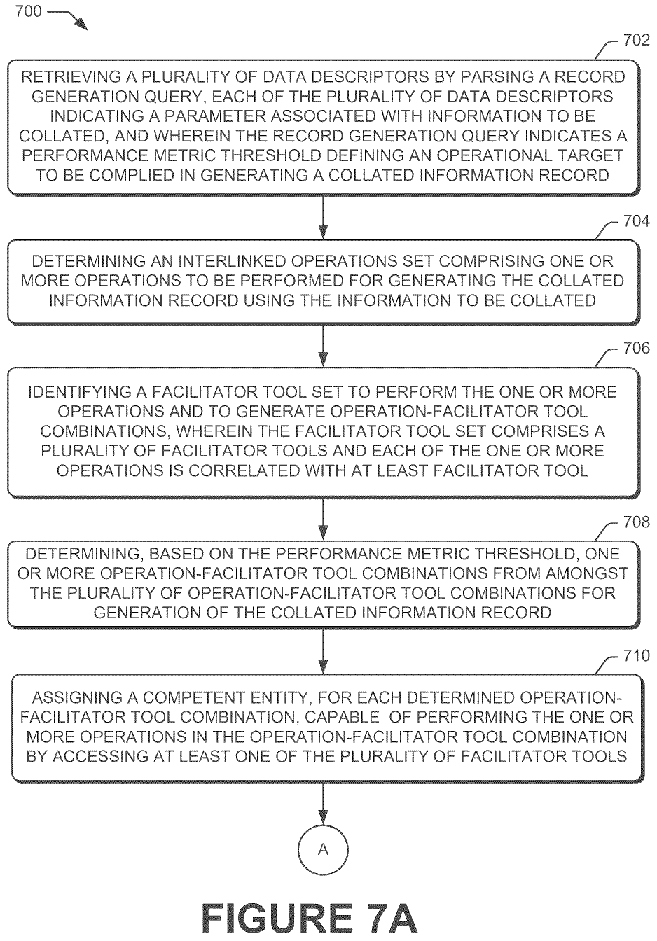

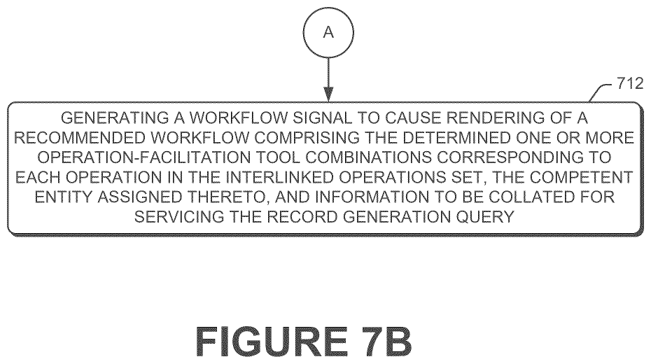

FIGS. 7A and 7B illustrate an exemplary method 700 for recommending a workflow to assist in generation of a collated information record. The order in which the method is described is not intended to be construed as a limitation, and any number of the described method blocks may be combined in any order to implement the method 700, or an alternative method. Furthermore, the method 700 may be implemented by processing resource or computing device(s) through any suitable hardware, non-transitory machine-readable instructions, or combination thereof.

It may also be understood that the method 700 may be performed by programmed computing devices, such as the processor 104, as depicted in FIGS. 1A-3. Furthermore, the method 700 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 700 is described below with reference to the processor 104 and the system 102 as described above; other suitable systems for the execution of these methods may also be utilized. Additionally, the implementation of these methods is not limited to such examples.

FIGS. 7A and 7B illustrate the method 700 for recommending a workflow to assist in generation of a collated information record, according to an example implementation of the present subject matter.

At block 702, a plurality of data descriptors may be retrieved by parsing a record generation query. The plurality of data descriptors may indicate a parameter associated with information to be collated for servicing the record generation query. In one example, the plurality of data descriptors may be retrieved in response to receipt of the record generation query. The record generation query may be received, for example, through a graphical user interface, an application, a web page, a tool, a platform, or a user device. Further, examples of the one or more descriptors may include, but are not limited to, theme, topic, tags, labels, characteristics, type of data, and other identifying information. Further, the information to be collated may be data obtained from one or more of the data sources 106 based on the one or more data descriptors retrieved from the record generation query. for example, data that may be semantically similar to the data descriptors and/or the record generation query may be obtained from the one or more data sources 106.

In one example, the record generation query may indicate a performance metric threshold for generating a collated information record. The performance metric threshold, in one example, may define an operational target to be complied in generating the collated information record. The operational target may include, for example, at least one of a processing time threshold, a resource utilization threshold, a cost threshold, a service level agreement (SLA) threshold, and a combination thereof.

At block 704, an interlinked operations set may be determined. The interlinked operations set comprises one or more operations to be performed for generating a collated information record using the information to be collated. In one example, the interlinked operations set, having the one or more operations, may be determined based on at least one of the information to be collated and the one or more data descriptors. For example, as discussed above, the mappings or matrix developed based on the historical collated information record and/or the contextual information element may be utilized to determine the one or more operations. For example, the processor 104 may utilize such mappings to determine the one or more operations that were performed to generate the historical collated information record that comprises information similar to the information to be collated for servicing the record generation query. Further, the interlinked operations set may be indicative of at least a sequence of execution of the one or more operations to be performed for the generation of the collated information record. The sequence of execution of the one or more operations may be determined in one example, based on the mappings discussed above. In another example, the processor 104 may determine the sequence based on the causal relationship between the one or more operations in the interlinked set of operations, as discussed above.

At block 706, a facilitator tool set may be identified to perform the one or more operations of the interlinked operations set. The facilitator tool set may include a plurality of facilitator tools, such as the facilitator tools 108, and each of the one or more operations may be correlated with at least one of the plurality of facilitator tools 108. In one example, the mappings, discussed above, may be utilized to determine the facilitator tools 108 that were utilized for performing the one or more operations involved in generation of the historical collated information record having semantic conformance with the information to be collated.

In another example, a historical collated information record previously generated by one or more designated competent entities, such as the designated competent entities 110, and a contextual information element associated with the historical collated information record may be obtained. In one example, the historical collated information record may include data semantically similar to the information to be collated. Further, the contextual information element may indicate, in one example, the facilitator tools 108 used by each of the one or more designated competent entities 110 for each operation performed in generation of the historical collated information record. Such historical collated information record, in one example, may be parsed to determine or select a facilitator tool from amongst the facilitator tools 108 for each of the operations. Further, as one or more facilitator tools may be identified for each of the one or more operations in the interlinked operations set, a plurality of operation-facilitator tool combinations may be generated, as discussed above and exemplarily illustrated in FIGS. 4A to 4C.

At block 708, one or more operation-facilitator tool combinations may be determined, based on the performance metric threshold, from amongst the plurality of operation-facilitator tool combinations for generation of the collated information record. In one example, each of the operations and the facilitator tools may have a performance cost associated therewith. The performance cost may be, for example, in terms of processing time, resource utilization, cost, SLA, and a combination thereof. In one example, for each of the plurality of operation-facilitator tool combinations, a performance cost may be determined. The performance cost may be, for example, a weighted average of the performance cost of the one or more operations and the performance cost of the facilitator tool, the one or more operations and the facilitator tool forming an operation-facilitator tool combination. In one example, the performance cost for each operation and the facilitator tool may be determined based on experience and previous executions. For example, the processing time, resource utilization, and/or cost may be determined based on the previous execution of the operation with the facilitator tool. In one example, the performance cost may also be defined by one or more users, for example, professionals or administrators. For example, the one or more users may define the SLA for the operation and the facilitator tool. In one example, the performance cost for each operation and the facilitator tool may be determined and then stored in the one or more data stores 302 for being accessible. In another example, the performance cost of each operation with the corresponding facilitator tool may be pre-defined and stored in the one or more data stores 302. For example, the performance cost may be defined by the one or more used.

Based on the performance cost of each of the operation-facilitator tool combinations, at least one of the operation-facilitator tool combinations may be determined. For example, the performance cost of each operation-facilitator tool combination may be compared with the performance metric threshold indicated in the record generation query. In one example, only the operation-facilitator tool combination having a performance cost less than or equal to the performance metric threshold may be determined for generating the collated information record. Thus, the selection of one or more operation-facilitator tool combinations may involve evaluating various combinations of operations and facilitator tools against predetermined performance criteria. This approach may ensure that the chosen combinations optimize efficiency and resource utilization while meeting the required performance standards. Thus, a sophisticated process may be implemented for selecting optimal combinations of operations and facilitator tools to generate the collated information record. For example, the most efficient and cost-effective method for generating collated information records may be determined. Further, by considering multiple factors and leveraging both historical data and user-defined parameters, the method may adapt to changing requirements and resource constraints. This flexibility may allow for optimal resource allocation, improved processing speeds, and better adherence to SLA.

At block 710, a competent entity may be assigned for each determined operation-facilitator tool combination. In one example, the competent entity assigned for an operation-facilitator tool combination may be an entity, such as the designated competent entity 110, capable of performing the one or more operations in the operation-facilitator tool combination by accessing at least one of the plurality of facilitator tools. For example, for each of the one or more operations in the operation-facilitator tool combination, where each operation has at least one facilitator tool correlated therewith, a competent entity may be determined and assigned. Similarly, a competent entity may be assigned for each of the operation-facilitator tool pair. FIGS. 5A to 5C illustrate a few examples of such combinations of the one or more competent entities with operation-facilitator tool combinations.

In one example, the assignment of the competent entity, from amongst the plurality of competent entities 110, may be based on an entity proficiency indicator associated with each of the plurality of competent entities for the facilitator tool in the operation-facilitator tool combinations. For example, each of the plurality of competent entities may have an entity proficiency indicator associated therewith for a facilitator tool. The entity proficiency indicator may indicate the capability or ability of a competent entity to perform an operation by utilizing a facilitator tool. The entity proficiency indicator may comprise, in one example, a positive indicator and a negative indicator. The competent entity having the negative indicator, in one example, may be determined as not capable of performing the operation by utilizing the facilitator tool. Such a competent entity may not be assigned for performing the operation by accessing the facilitator tool for performing that operation. In one example, such a competent entity may be restricted from utilizing or accessing that facilitator tool. However, the competent entity, having the positive indicator, may be determined to be capable of performing the operation by utilizing the facilitator tool. Such a competent entity may be allowed to access that facilitator tool for performing the operation. The method may then flow to block A.

From block A and at block 712, a workflow signal may be generated to cause rendering of a recommended workflow comprising the determined operation-facilitation tool combinations corresponding to each operation in the interlinked operations set, competent entity assigned thereto, and information to be collated for servicing the record generation query. Once the competent entity is assigned for each determined operation-facilitator tool combination, the workflow signal may be generated to cause rendering of the recommended workflow for each assigned competent entity. The recommended workflow may comprise, for each competent entity, the operation in the interlinked operations set, the facilitator tool identified for performing the operation, and information to be collated for servicing the record generation query. For example, the workflow may include the specific operation that needs to be performed by the assigned competent entity. This may ensure that each competent entity knows exactly what operation they have to perform in the overall workflow process. The workflow may also identify the facilitator tool for carrying out that operation. The workflow may also provide details about the information that needs to be gathered from the data sources 106 and applied with the operation to effectively service the record generation query. This information may be crucial for ensuring that the competent entity has at least the necessary data to complete its assigned operation accurately and efficiently. Similarly, there may be multiple competent entities, and one or more operations and tools being indicated in the workflow. The recommended workflow, in one example, may thus be executable for generation of the collated information record.

Further, generation of the workflow signal may cause rendering of the recommended workflow, for example, on a graphical user interface, system, device, application, or platform. In one example, the competent entities may be able to view such recommended workflow and accordingly initiate execution of the workflow for generation of the collated information record. The collated information record may be the outcome of the execution of the recommended workflow. The collated information record can be in different forms, for example, in the form of processed data, files, documents, or records.

Further, in one example, a correlation between the determined operation-facilitation tool combinations corresponding to each operation in the interlinked operation set, the competent entity assigned thereto, and the information to be collated for servicing the query may be stored in a mapping or matrix. For example, the matrix may be stored in the one or more data stores 302.

Further, in one example, prior to performing an operation in the sequence of execution indicated in the interlinked operation set, a source schema may be identified for a plurality of data objects within the information to be collated. In one example, the source schema may be indicative of a format of the plurality of data objects retrieved from a data source, such as the data source 106, generating data objects pertinent to the information to be collated. Further, the source schema may be assessed to determine one or more transformation actions to be performed on the plurality of data objects for converting the plurality of data objects from a source schema to a target schema. The target schema may be a schema in schematic compliance with an operational routine facilitating the operation. In one example, the operational route may be a predefined set of actions performed to generate an output of at least one of the one or more operations in the interlinked operations set.

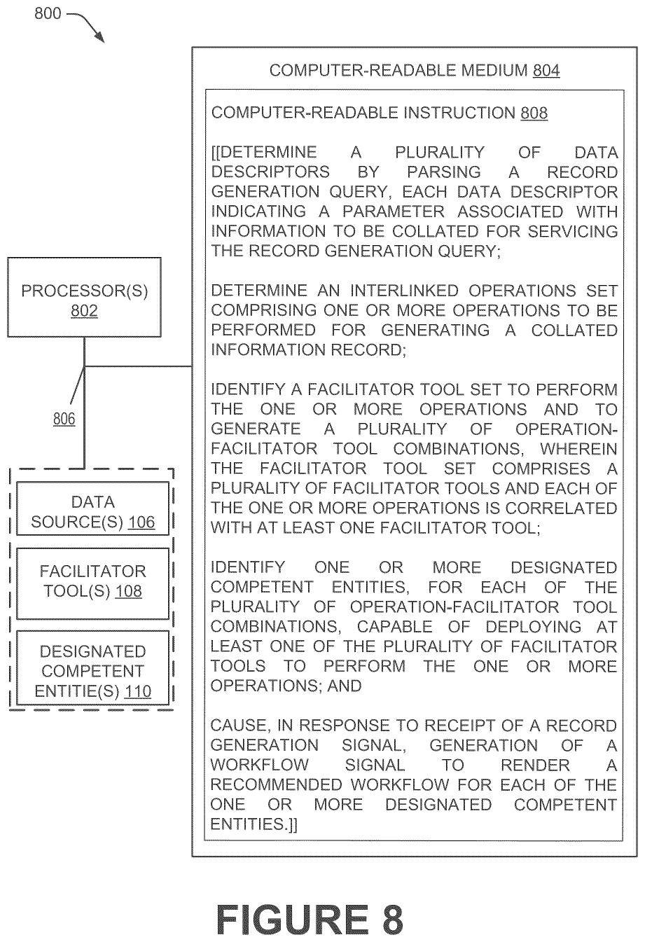

FIG. 8 illustrates a non-transitory computer-readable medium for recommending a workflow for generating collated information record, in accordance with an example of the present subject matter.

In an example, the computing environment 800 includes a processor 802 communicatively coupled to a non-transitory computer-readable medium 804 through communication link 806. In an example, the processor 802 may have one or more processing resources for fetching and executing computer-readable instructions from the non-transitory computer-readable medium 804. The processor 802 and the non-transitory computer-readable medium 804 may be implemented, for example, in the system 102.

The non-transitory computer-readable medium 804 may be, for example, an internal memory device or an external memory. In an example implementation, the communication link 806 may be a network communication link, or other communication links, such as a PCI (Peripheral component interconnect) Express, USB-C (Universal Serial Bus Type-C) interfaces, I2C (Inter-Integrated Circuit) interfaces, etc. In an example implementation, the non-transitory computer-readable medium 804 includes a set of computer-readable instructions 808 which may be accessed by the processor 802 through the communication link 806 and subsequently executed for reconfiguring the data pipeline. The processor 802 and the non-transitory computer-readable medium 804 may also be communicatively coupled to the data source(s) 106, the facilitator tool(s) 108, and the designated competent entitie(s) 110.

Referring to FIG. 8, in an example, the non-transitory computer-readable medium 804 includes computer-readable instructions 808 that may cause the processor 802 to determine a plurality of data descriptors by parsing a record generation query, as discussed above. The plurality of data descriptors may indicate a parameter associated with information to be collated for servicing the record generation query.

In one example, the non-transitory computer-readable medium 804 includes computer-readable instructions 808 that may further cause the processor 802 to determine an interlinked operations set including one or more operations to be performed for generating the collated information record using the information to be collated. In one example, the mappings or matrix developed based on the historical collated information record and/or the contextual information element, as discussed above, may be utilized to determine the one or more operations. Further, in one example, the interlinked operations set may be indicative of at least a sequence of execution of the one or more operations to be performed for the generation of the collated information record. The sequence of execution of the one or more operations may be determined in one example, based on the mappings discussed above. In another example, the processor 104 may determine the sequence based on the causal relationship between the one or more operations in the interlinked set of operations, as discussed above.

In one example, the non-transitory computer-readable medium 804 includes computer-readable instructions 808 that may further cause the processor 802 to identify a facilitator tool set to perform the one or more operations of the interlinked operation set and to generate a plurality of operation-facilitator tool combinations, as discussed above. The facilitator tool set comprises a plurality of facilitator tools. Further, each of the one or more operations may be associated or correlated with at least one of the plurality of facilitator tools in each of the plurality of operation-facilitator tool combinations. In one example, the mappings, discussed above, may be utilized to determine the one or more facilitator tools that were utilized by the one or more designated competent entities 110 for performing the one or more operations involved in generation of the historical collated information record.

In another example, the processor 802 may obtain a historical collated information record generated or submitted by the one or more designated competent entities 110 and a contextual information element associated with the historical collated information record. Further, the contextual information element may indicate, in one example, the one or more facilitator tools 108 used by each of the one or more designated competent entities 110 for each operation performed in generation of the historical collated information record. The processor 802, may parse the historical collated information record to determine a proficiency score for each of the one or more facilitator tools. Based on the proficiency score, the processor 802 may select at least one facilitator tool from amongst the one or more facilitator tools 108 for each of the operations. In one example, the facilitator tool having the proficiency score greater than a proficiency threshold may be selected by the processor 104. Thus, in one example, for each of the operations, the processor 802 may select at least one facilitator tool based on their corresponding proficiency score.

Further, as one or more facilitator tools may be identified for each of the operations in the interlinked operations set, a plurality of operation-facilitator tool combinations may be generated, as discussed above. That is, each of the operations in the interlinked operations set may have at least one of the plurality of facilitator tools 108 correlated therewith.

Further, in an example, the non-transitory computer-readable medium 804 includes computer-readable instructions 808 that may further cause the processor 802 to identify one or more designated competent entities, from amongst the plurality of designated competent entities 110, for each of the plurality of operation-facilitator tool combinations. In one example, each of the one or more designated competent entities 110 may be capable of deploying at least one of the plurality of facilitator tools 108 to perform the one or more operations in the interlinked operations set. For example, for each of the operations in the interlinked set of operations, where each operation has at least one facilitator tool correlated therewith, the processor 802 may determine one or more designated competent entities 110 for that operation. Similarly, one or more designated competent entities 110 may be determined for each of the operation-facilitator tool pairs.

In one example, the one or more designated competent entities, from amongst the plurality of designated competent entities 110, may be determined based on an entity proficiency indicator associated with each of the plurality of designated competent entities 110 for a facilitator tool. For example, each of the plurality of designated competent entities 110 may have an entity proficiency indicator associated therewith for using a facilitator tool. In one example, the entity proficiency indicator may indicate the capability or ability of a designated competent entity to perform an operation by utilizing a facilitator tool. The entity proficiency indicator may comprise, in one example, a positive indicator and a negative indicator. For the designated competent entity 110 having the negative indicator, the processor 802 may determine that that designated competent entity 110 may not be capable of performing the operation by utilizing the facilitator tool 108. The processor 104 may thus not identify such designated competent entity 110 for performing the operation by utilizing the facilitator tool 108. In one example, the processor 802 may restrict such one or more designated competent entities 110 from deploying that facilitator tool 108. However, for the designated competent entity 110 having the positive indicator, the processor 802 may determine that that designated competent entity 110 may be capable of performing the operation by utilizing the facilitator tool 108 for performing that operation. The processor 104 may thus determine such designated competent entity 110 for performing the operation by utilizing the facilitator tool 108 for that operation. In one example, the processor 104 may allow such one or more designated competent entities 110 to deploy the facilitator tool 108 for performing the operation.

Further, in an example, the non-transitory computer-readable medium 804 includes computer-readable instructions 808 that may further cause the processor 802 to cause generation of a workflow signal to render a recommended workflow for each of the one or more designated competent entities. The recommended workflow may include, for each of the one or more designated competent entities 110, the one or more operations in the interlinked operation set for those one or more designated competent entities 110; the plurality of facilitator tools 108 identified for the one or more designated competent entities 110 for performing each of the one or more operations; and the information to be collated for servicing the record generation query. Further, the recommended workflow is executable for generation of the collated information record. For example, the steps indicated in the workflow may be followed or executed by the one or more designated competent entities 110 in order to generate the collated information record.

In one example, generation of the workflow signal may be in response to reception of a record generation signal. That is, in one example, determination of the interlinked operations set, identification of the operation-facilitator tool combinations, and identification of the one or more designated competent entities 110 may be kept ready and the recommended workflow may be generated upon receipt of the record generation signal. In one example, the record generation signal may be triggered, on the elapse of a predefined time period, as discussed above. At elapse of the predefined time period, the record generation signal may be generated, in response to which, the recommended workflow for generating the correlated information record may be rendered. Such an implementation may be useful in scenarios where the workflow, or the collated information record, may have to be generated in a periodic or regular manner, for instance, for monitoring purposes. In another example, the record generation signal may be triggered on user input or request. The user input or request may be received, for example, via one or more user devices, applications, or platforms.

Although examples of the present subject matter have been described in language specific to methods and/or structural features, it is to be understood that the present subject matter is not limited to the specific methods or features described. Rather, the methods and specific features are disclosed and explained as examples of the present subject matter.

What is claimed is:

1. A system comprising:
a processor to:
retrieve, in response to receipt of a record generation signal, one or more data descriptors by parsing a record generation query, each of the one or more data descriptors indicating a parameter associated with information to be collated for servicing the record generation query;
determine an interlinked operations set comprising one or more operations to be performed for generating a collated information record using the information, the interlinked operations set indicating a sequence of execution of the one or more operations;
identify a facilitator tool set to perform the one or more operations and to generate operation-facilitator tool combinations, the facilitator tool set comprising a plurality of facilitator tools, wherein each of the facilitator tool corresponds to a software tool configured to execute an operational routine for performing one or more operations on collated information record, wherein the collated information record is used for servicing the record generation query, and each of the one or more operations is correlated with at least one facilitator tool in each of the operation-facilitator tool combinations;
determine a designated competent entity, from amongst a plurality of designated competent entities and for each of the operation-facilitator tool combinations, capable of executing an operation in the interlinked operations set by utilizing a facilitator tool from amongst the plurality of facilitator tools; and
cause generation of a workflow signal to render a recommended workflow for each designated competent entity, the recommended workflow comprising the operation in the interlinked operations set, the facilitator tool identified for performing the operation, and the information to be collated.

2. The system of claim 1, wherein the recommended workflow is executable for generation of the collated information record, and wherein the sequence of execution of the one or more operations to be performed for the generation of the collated information record is determined based on a causal relationship between one or more operations in the interlinked operations set.

3. The system of claim 2, wherein at least one of the plurality of facilitator tools comprises a transformative unit executable for transforming a plurality of data objects in the information to be collated, the transformation being for schematic compliance of the plurality of data objects with an operational routine of the plurality of facilitator tools, the operational routine being a predefined set of actions performed to generate an output of at least one of the one or more operations in the interlinked operations set.

4. The system of claim 3, wherein the transformative unit is to:
identify a source schema for the plurality of data objects, the source schema being indicative of a format of the plurality of data objects retrieved from a data source, the data source generating data objects pertinent to the information to be collated; and
assess the source schema to determine one or more transformation actions to be performed on the plurality of data objects for converting the plurality of data objects from a source schema to a target schema, the target schema being in schematic compliance with the operational routine.

5. The system of claim 1, wherein, to identify the operation-facilitator tool combinations, the processor is to:
obtain a historical collated information record generated by one or more designated competent entities and a contextual information element associated with the historical collated information record, the contextual information element indicating the facilitator tools used by each of the one or more designated competent entities for each operation performed in generation of the historical collated information record;
parse the historical collated information record to determine a proficiency score for each of the facilitator tools; and
select a facilitator tool, from amongst the facilitator tools, having a proficiency score greater than a proficiency threshold for each operation.

6. The system of claim 1, wherein the determination of the designated competent entity, from amongst the plurality of designated competent entities, is based on an entity proficiency indicator associated with each of the plurality of designated competent entities for a facilitator tool.

7. The system of claim 6, wherein the entity proficiency indicator comprises one of a positive indicator and a negative indicator, wherein the processor is to restrict the designated competent entity from utilizing the facilitator tool with the negative indicator, and wherein the processor is to allow the designated competent entity to utilize the facilitator tool with the positive indicator.

8. The system of claim 6, wherein the processor is to update the entity proficiency indicator based on information from a training management module, the training management module comprising records of training provided to the designated competent entity in relation to the plurality of facilitator tools.

9. A method comprising:
retrieving, in response to receipt of a record generation query, a plurality of data descriptors by parsing the record generation query, each of the plurality of data descriptors indicating a parameter associated with information to be collated for servicing the record generation query, and wherein the record generation query indicates a performance metric threshold defining an operational target to be complied in generating a collated information record;
determining an interlinked operations set comprising one or more operations to be performed for generating the collated information record using the information, the interlinked operations set indicating a sequence of execution of the one or more operations;
identifying a facilitator tool set to perform the one or more operations and to generate operation-facilitator tool combinations, wherein the facilitator tool set comprises a plurality of facilitator tools, wherein each of the facilitator tool corresponds to a software tool configured to execute an operational routine for performing one or more operations on collated information record, wherein the collated information record is used for servicing the record generation query, and each of the one or more operations is correlated with at least one facilitator tool in each of the operation-facilitator tool combinations;
determining, based on the performance metric threshold, one or more operation-facilitator tool combinations from amongst the plurality of operation-facilitator tool combinations for generation of the collated information record;
assigning a competent entity, for each determined operation-facilitator tool combination, capable of performing the one or more operations in the operation-facilitator tool combination by accessing at least one of the plurality of facilitator tools;
generating a workflow signal to cause rendering of a recommended workflow comprising the determined one or more operation-facilitation tool combinations corresponding to each operation in the interlinked operations set, the competent entity assigned thereto, and the information to be collated for servicing the record generation query.

10. The method of claim 9, wherein the operational target indicated in the performance metric threshold includes one of a processing time threshold, a resource utilization threshold, a cost threshold, a service level agreement (SLA) threshold, and a combination thereof.

11. The method of claim 9, wherein, prior to performing an operation in the sequence of execution indicated in the interlinked operation set, the method comprises:
identifying a source schema for a plurality of data objects, the source schema being indicative of a format of the plurality of data objects retrieved from a data source generating the data objects pertinent to the information to be collated based on the plurality of data descriptors; and
assessing the source schema to determine one or more transformation actions to be performed on the plurality of data objects for converting the plurality of data objects from a source schema to a target schema, the target schema being in schematic compliance with an operational routine facilitating the operation, the operational routine being a predefined set of actions performed to generate an output of at least one of the one or more operations in the interlinked operations set.

12. The method of claim 9, wherein the competent entity is assigned for each determined operation-facilitator tool combination based on an entity proficiency indicator associated with the competent entity for the facilitator tool in the operation-facilitator tool combinations, the entity proficiency indicator comprises a positive indicator and a negative indicator, wherein the competent entity is restricted from accessing the facilitator tool with the negative indicator, and wherein the competent entity is allowed to access the facilitator tool with the positive indicator.

13. The method of claim 9, wherein the sequence of execution of the one or more operations is determined based on a causal relationship between one or more operations in the interlinked operations set.

14. The method of claim 9, wherein the method comprises storing a correlation between the determined one or more operation-facilitation tool combinations corresponding to each operation in the interlinked operation set, the competent entity assigned thereto, and the information to be collated for servicing the query in a matrix.

15. A non-transitory computer-readable medium comprising instructions, the instructions being executable by a processing resource to:
determine a plurality of data descriptors by parsing a record generation query, each data descriptor indicating a parameter associated with information to be collated for servicing the record generation query;
determine an interlinked operations set comprising one or more operations to be performed for generating a collated information record using the information, the interlinked operations set indicating a sequence of execution of the one or more operations;
identify a facilitator tool set to perform the one or more operations and to generate operation-facilitator tool combinations, wherein the facilitator tool set comprises a plurality of facilitator tools, wherein each of the facilitator tool corresponds to a software tool configured to execute an operational routine for performing one or more operations on collated information record, wherein the collated information record is used for servicing the record generation query, and each of the one or more operations is correlated with at least one facilitator tool in each of the operation-facilitator tool combinations;
identify one or more designated competent entities, for each of the operation-facilitator tool combinations, capable of deploying at least one of the plurality of facilitator tools to perform the one or more operations in the interlinked operations set; and
cause, in response to receipt of a record generation signal, generation of a workflow signal to render a recommended workflow for each of the one or more designated competent entities, the recommended workflow comprising the one or more operations in the interlinked operation set, one or more facilitator tools identified for performing each of the one or more operations, and the information to be collated for servicing the record generation query, wherein the recommended workflow is executable for generation of the collated information record.

16. The non-transitory computer-readable medium of claim 15, wherein the record generation signal is triggered by one of an elapse of a predefined time period and a user input.

17. The non-transitory computer-readable medium of claim 15, wherein the sequence of execution of the one or more operations to be performed for the generation of the collated information record is determined based on a causal relationship between one or more operations in the interlinked operations set.

18. The non-transitory computer-readable medium of claim 15, wherein to identify the operation-facilitator tool combinations, the instructions being executable by a processing resource to:
obtain a historical collated information record generated by one or more designated competent entities and a contextual information element associated with the historical collated information record, the contextual information element indicating the one or more facilitator tools used by the one or more designated competent entity for each operation performed in generation of the historical collated information record;
parse at least one of the historical collated information record and the contextual information element to determine a proficiency score for each of the one or more facilitator tools; and
select at least one facilitator tool, from amongst the one or more facilitator tools, based on the proficiency score of each of the one or more facilitator tools.

19. The non-transitory computer-readable medium of claim 15, wherein the determination of the one or more designated competent entities is based on an entity proficiency marker associated with each of the one or more designated competent entities for a facilitator tool.

20. The non-transitory computer-readable medium of claim 15, wherein the entity proficiency indicator comprises one of a positive indicator and a negative indicator, wherein the processing resource is to restrict the one or more designated competent entities from deploying the facilitator tool with the negative indicator, and wherein the processing resource is to allow the one or more designated competent entities to deploy the facilitator tool with the positive indicator.
